(19) United States
(12) Patent Application Publication
(10) Pub. No.: US 2012/0044323 A1
(43) Pub. Date: Feb. 23, 2012

(54) Method and Apparatus for 3D Image and Video Assessment

(75) Inventors: Ming-Jun Chen, Austin, TX (US); Do-Kyoung Kwon, Allen, TX (US)

(73) Assignee: TEXAS INSTRUMENTS INCORPORATED, Dallas, TX (US)

(21) Appl. No.: 13/214,651

(22) Filed: Aug. 22, 2011

Related U.S. Application Data
(60) Provisional application No. 61/375,303, filed on Aug. 20, 2010.

(51) Int. Cl. H04N 13/00

(52) U.S. Cl. 348/43; 348/E13.002

(57) ABSTRACT

A method and apparatus for assessing 3 dimensional video. The method includes computing at least one of 3 dimensional quality and geometric quality, and combining two quality values for overall 3 dimensional quality assessment.

### CROSS-REFERENCE TO RELATED APPLICATIONS

This application claims benefit of U.S. provisional patent application Ser. No. 61/375,303, filed Aug. 20, 2010, which is herein incorporated by reference.

### BACKGROUND OF THE INVENTION

1. Field of the Invention

Embodiments of the present invention generally relate to a method and apparatus for 3D image and video assessment.

2. Description of the Related Art

In the field of 3D video and image quality assessment, the current 3D quality metric usually does not reflect the true 3D video quality which human perceive. This is due to the fact that the metrics does not deal with the convergence problem and the measured 3D quality is not well correlated with human perception.

When generating a 3D stereoscopic video, the depth in the real world has to be rescaled to display on a stereoscopic displayer. While the human eyes can change focus and convergence points in binocular vision, in the stereoscopic displayer, focus point has to be directed on the screen and eye convergence changed to experience a 3D effect. Fixing focus point limits the range of depth seen in stereoscopic 3D displayer and eye strain increases when the depth range increases. If the depth range is larger than certain threshold, viewers stop seeing 3D video and start seeing ghosting video. This happens when the human eye can not converge two views correctly with a fixed focus point on the screen. To measure if the tested stereo content gives the viewer any uncomfortable 3D viewing experience or ghosting video, the geometric quality metric is proposed in our invention.

Assuming that the processed videos are well rectified, the discomfort factor and convergence issue would be one of main problems in viewing 3D stereoscopic video. There exists 3D video quality metrics used to measure the 3D video quality nowadays. However, these metrics not only can not deal with the convergence issue caused from the stereo video capturing process, but they also do not have very good correlation with human perception in 3D video. Our invention first deal with the geometric issue of the stereo content, then evaluate the video quality without considering the perceived depth quality.

### SUMMARY OF THE INVENTION

Embodiments of the present invention relate to a method and apparatus for assessing 3D video. The method includes assessing geometric 3D quality, for example, by counting the number of disparity values that are larger than a certain threshold, assessing spatial 3D quality using any existing method, and combining two qualities for overall 3D quality assessment.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an embodiment of for illustration of convergence issue;

FIG. 2 is an embodiment of a graphical use interface of a first experiment;

FIG. 3 is an embodiment of a graphical user interface of a second experiment;

FIG. 4 is an embodiment of a mean of standard deviations of ratings on all video;

FIG. 5 is an embodiment of a table depicting means of correlation;

FIG. 6 is an embodiment of a prior stereo 3D video assessment system;

FIG. 7 is an embodiment of an improved 3D video assessment system; and

FIG. 8 is a flow diagram for a method for assessing 3D video.

### DETAILED DESCRIPTION

Assuming the tested video sequences were already rectified, the proposed system evaluates the quality of the stereo video using two metrics. The first metric measures the quality of geometric setting for the stereo video. Human will feel high eye pressure and uncomfortable if there is any convergence issue or unnatural depth setting in the video. Our invention analyzes the depth map to measure the quality of the geometric setting.

The second metric measures the 3D video quality based on perceived video quality only. From our study, we know that the prediction of the perceived depth quality may be unreliable because there is a lack of general agreement on the perceived depth quality among different subjects. Evaluating 3D video quality only based on perceived video quality leads to more precisely prediction on 3D video quality.

The convergence problem is affect by the size of the display screen, the resolution of the display screen and the distance from the viewer to the screen. Some research shows that most people will tolerate a change in convergence angle of up to 1.6 degree. If the convergence angle exceeds the threshold, it causes a convergence conflict and viewers will have troubles in seeing 3D stereoscopic image.

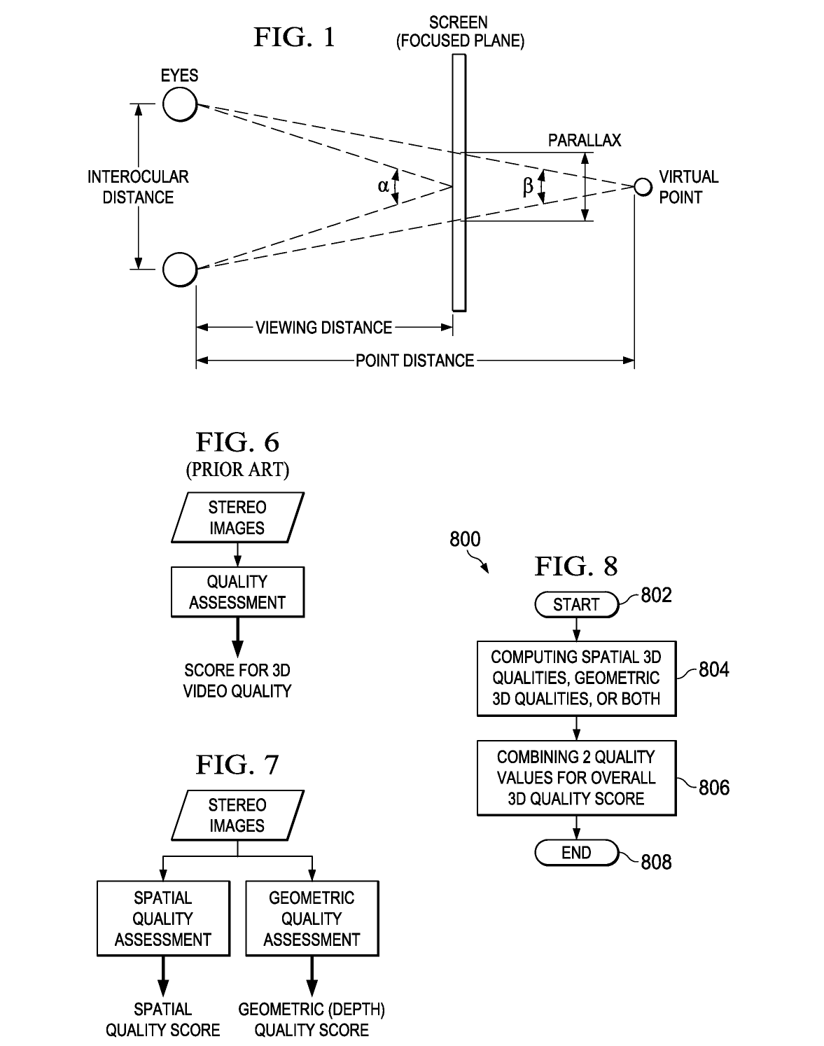

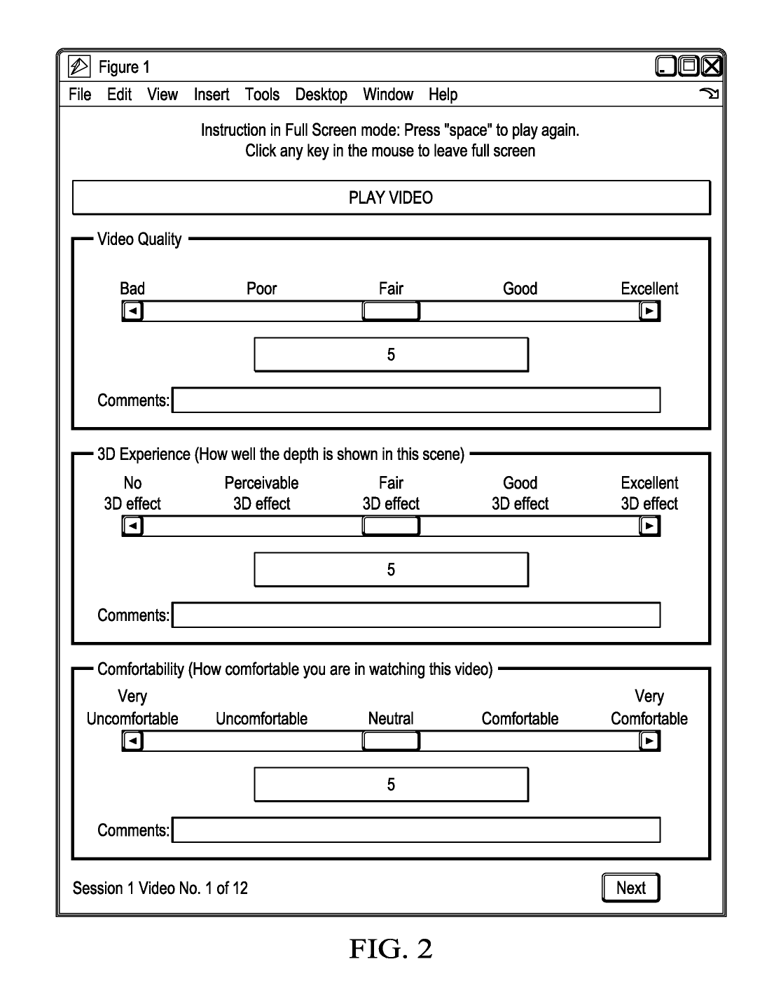

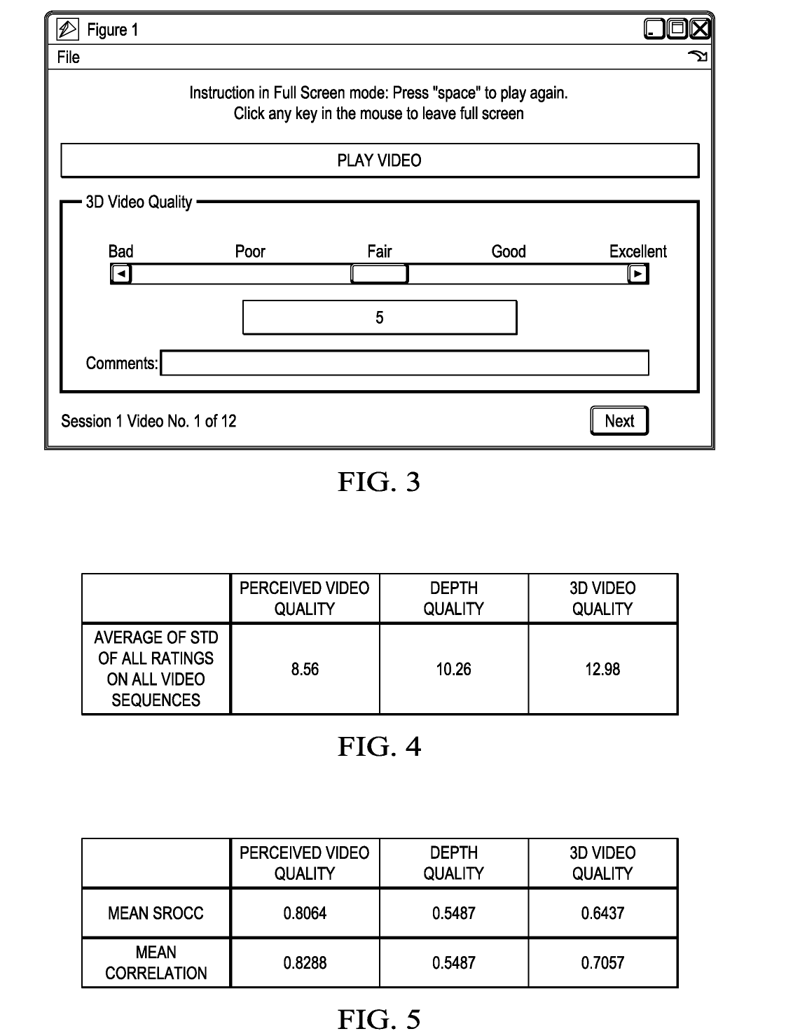

FIG. 1 is an embodiment of for illustration of convergence issue. FIG. 1 shows the setting for the stereoscopic viewing. To convergence the stereo views, the following should be satisfied:

θ=α−β<3.2°

Thus, using the following equation, the maximum allowable disparity value is calculated as follows:

max disparity=0.03*View Distance*horizontal screen resolution/width of the screen.

Then convergence score Con is defined as follows:

$$Con ( {I}_{xy} , VD , HS , WS ) = \begin{matrix}0 & if {I}_{xy} > {Max}_{disparity} \\ 1 & if {I}_{xy} < {Max}_{disparity} ,\end{matrix}$$

where I_{xy} is the pixel value of the disparity map I at position (x, y), VD is the viewing distance, HS is the horizontal screen resolution and WS is the width of the screen.
Then the convergence score of an image I is defined as:

$${QS}_{congerence} = {\sum }_{y = 1}^{y = height} {\sum }_{x = 1}^{x = width} Con ( {I}_{xy} , VD , HS , WS ) / width * height ,$$

where width and height are the image width and height in terms of pixel, respectively.

Two subjective studies on 3D video quality with same video sequences has been conducted. In the first study, subjects were asked to give three independent quality scores (0-10 to perceived video quality, depth perception quality, and comfortability, 10 means the best) to each video. In the second study, subjects were requested to give only one overall 3D video quality score (0-10) to each video.

From the post-interviews, the task of giving an overall 3D video quality score was much more difficult than to give a perceived video quality score and a perceived depth quality score separately. With statistical analysis, the subjects had a higher agreement (0.8288) on spatial video quality, while diverse opinions (0.5487) were observed on perceived depth quality and overall 3D video quality. Hence, we propose to focus on perceived video quality on performing the 3D video quality assessment task.

Assuming there are two 3D videos A and B, where A has slightly better perceived video quality than B, but B has slightly better depth perception quality than A. To determine if humans have an agreement on which video has better overall 3D video quality, a 3D video subjective testing was conducted using 6 uncompressed natural scene videos. The videos included indoor and outdoor scenes from the as source videos. The videos were down-sampled to 720×480 resolution. 2 out of 6 videos were 15 seconds long, while the rest of them were 10 seconds long. All sequences had a frame rate of 25 frames per second.

In the experiment, the asymmetric coding of stereo video is also our interest. To conduct the experiment within a reasonable time period, only the H.264 compression distortion was included in this experiment. Each reference sequence has 9 distorted test sequences coding with different QP values.

The experiment was conducted in a lab utilizing full HD 3D monitor to show 3D videos. The viewing distance from the viewer to the screen was fixed as 3 times of the screen height. A single stimulus continuous quality evaluation (SSCQE) was used to obtain the subjective quality rating for the video sequences in the database. A training section was given to each subject in the beginning of the experiment to make sure that their binocular vision work well with our 3D display device and helped them to be familiar with the user interface and the range of visual quality they could expect in the study. The training content was different from the videos of the study and was impaired using the same distorted type. Repeated viewing of the same 3D video was allowed since we found that subjects needed time to change their eye convergence to go through the 3D scenes.

To understand subjects' ratings of the perceived video quality, the depth quality, and the overall 3D video quality, the experiment was conducted twice with the same video sequences, but different questions. In both experiments, 11 video sequences, 3D reference video, 2D reference video (right view), 9 distorted videos, were shown to the subjects. 3D reference video was the hidden reference for calculating DMOS score, and 2D reference was the baseline for the ratings on depth quality. Different subjects were used in the first study and second study.

In one embodiment, we asked the subjects to rate the quality of the tested video with three independent bars, video quality, 3D experience, and comfortability. The video quality is defined as perceived video quality without considering the depth perception. 3D experience is the quality score on depth perception. Comfortablility indicates how comfortable the subject is in viewing the video. There were 13 subjects participated in this experiment, their ages were from 24 to 45. FIG. 2 shows the graphical user interface in the first experiment. In the second experiment, subjects were only requested to give ratings on overall 3D video quality. There were 14 subjects in this test. Their ages were from 24 to 50. The graphical user interface is shown in FIG. 3.

The DMOS score were calculated by subtracting the ratings of 3D reference video on each rating. Then the different scores were converted to Z-scores per session. Next, to remove the outlier in the experiment, the ratings of all subjects in each experiment are assumed to be a Gaussian distribution. The outlier is someone who has very different rating behaviors compared to all others. Based on this assumption, the following steps to remove outliers are performed:
1. Utilize the mean value of all subjects' ratings as DMOS score of the database.
2. Calculate the SROCC value between every subject's rating and the DMOS score. If there is a general agreement on the video quality among subjects, the distribution of the ratings between different subjects is assumed to be a Gaussian distribution.
3. The ratings which are outside 2× standard deviations are chosen as outliers and are removed from the database.
4. Finally, the DMOS score of each video was computed as the mean of the rescaled Z-scores from the remaining subjects after subject rejection.

The post-interview was conducted in both experiments. Five subjects were interviewed right after they conducted the experiment. Four out of five subjects in the second study mentioned that they had troubles in giving ratings, while only one subject indicated that he had difficulty in giving ratings in the first study. The problem subjects had in the second study was that they did not know how to combine the video quality score and depth perception scores into an overall 3D video quality score, and in the first study, the subject had difficulty in rating depth perception quality.

To find out whether there is an agreement among the quality ratings of different subjects, two metrics were used. First, the variation of the ratings were reported. The standard deviation of the normalized ratings were calculated and Z-scores which were normalized to 0˜100 were given on each video. The average of these standard deviation values is reported in FIG. 4 to show the degree of agreement of the ratings. FIG. 4 is an embodiment of a mean of standard deviations of ratings on all video. From FIG. 4, it is noted that the ratings given to the perceived video quality have the minimum variation. However, based on these values, it is difficult to claim if there is a significant difference between the ratings given to perceived video quality, perceived depth quality, and the overall 3D video quality.

Second, the correlation between the ratings given by different subjects was analyzed to see whether their ratings were similar for three kinds of ‘qualities’. We first calculated the correlation values between the DMOS score of our database and the ratings given by every subject. Then the average of these correlation values is reported to reflect the degree of agreement of the ratings among multiple subjects. FIG. 5 is an embodiment of a table depicting means of correlation. From FIG. 5, we can see that the ratings on perceived video quality have the highest agreement and the ratings on the depth perception are more diverse.

In some prior arts, it has been claimed that the quality of depth perception drops as the image quality lowers. However, in other prior arts, it also has been claimed that the perceived depth remains nearly the same even though the image quality is deteriorated. Although, the different arguments may be resulted from different experiment settings, in this study, people's perceived depth qualities are very diverse and the agreement may be difficult to achieve.

Thus, the human have a high agreement on perceived video quality, but more diverse opinions on the perceived depth quality. Hence, different from prior 3D video quality assessment systems, we propose to use two separate quality metrics for spatial 3D quality and geometric 3D quality (depth quality) when performing the 3D video quality assessment task.

For a 3D video sequence, it is easier to judge its perceived video quality, while different people may have more diverse opinions on its perceived depth quality. It can be argued that the subjects are more familiar with the distortions in perceived video quality. Since television was invented in late 1930s, human have been living with distorted videos for a long time. Hence, we are very good at recognizing distortions. However, there are limited 3D video content and display devices. For most people, 3D video viewing is still a pretty new experience. Viewing 3D video is a different task than the daily stereo vision. In our daily stereo vision, our eyes change convergence and focused point at the same time to perceive stereo vision. In viewing 3D video, we only change the convergence with fixed focus point on the screen). Our subject may not have enough experience in viewing 3D video to judge perceived depth quality. This may explain why our subjects have more diverse opinions on perceived depth qualities now.

FIG. 6 is an embodiment of a prior stereo 3D video assessment system; whereas, FIG. 7 is an embodiment of an improved 3D video assessment system. As shown in FIG. 6, prior 3D video quality assessment systems employ a single metric to evaluate overall stereo 3D video quality. However, in the prior art, the geometric quality (e.g. depth perception) is not captured well. This is resolved by utilizing two different quality metrics to measure the quality of the stereo content. The flowchart is shown in FIG. 7.

The advantage of the system using two metrics is the output quality scores leads to a better measurement in different applications. For example, in one embodiment, for stereo 3D video encoder, only the output of the spatial quality score is utilized to optimize the encoding algorithm. The depth quality may not be of concern when there is no way to change the depth quality during encoding. However, if we display 3D video and optimize the depth quality for the 3D video, the predicted spatial quality score won't provide much information about the depth quality. Hence, we need a geometric quality metric to help us optimize the 3D effect for display. When we need to evaluate overall 3D quality, we can combine these two quality scores for overall 3D video quality assessment.

FIG. 8 is a flow diagram for a method 800 for assessing 3D video. The method starts at step 802 and proceed to 804 and 806. At steps 804 and 806, the method 800 compute spatial and geometric 3D qualities, respectively. Step 804 and step 806 can be either parallelized or sequentially processed, or one of them can be processed. At stop 808, the method 800 can combine two quality values for overall 3D quality score. The method 800 ends at 810.

While the foregoing is directed to embodiments of the present invention, other and further embodiments of the invention may be devised without departing from the basic scope thereof, and the scope thereof is determined by the claims that follow.

1-3. (canceled)

4. A method of a digital processor for assessing 3 dimensional video, comprising:
computing at least one of 3 dimensional quality and geometric quality; and
combining two quality values for overall 3 dimensional quality assessment.

5. The method of claim 4, wherein the step of computing comprises:
assessing geometric 3 dimensional quality by counting the number of disparity values that are larger than a certain threshold; and
assessing spatial 3 dimensional quality using any existing method.

6. An apparatus for assessing 3 dimensional video, comprising:
means for computing at least one of 3 dimensional quality and geometric quality; and
means for combining two quality values for overall 3D quality assessment.

7. The apparatus of claim 6, wherein the means for computing comprises:
means for assessing geometric 3 dimensional quality by counting the number of disparity values that are larger than a certain threshold; and
means for assessing spatial 3 dimensional quality using any existing method.

8. A non-transitory computer readable medium storing computer instructions, when executed perform a method of a digital processor for assessing 3 dimensional video, the method comprising:
computing at least one of 3 dimensional quality and geometric quality; and
combining two quality values for overall 3 dimensional quality assessment.

9. The non-transitory computer readable medium of claim 8, wherein the step of computing comprises:
assessing geometric 3 dimensional quality by counting the number of disparity values that are larger than a certain threshold; and
assessing spatial 3 dimensional quality using any existing method.
